(19) United States
(12) Patent Application Publication
(10) Pub. No.: US 2022/0070669 A1
(43) Pub. Date: Mar. 3, 2022

(54) DIGITAL WIRELESS PRIVATE COMMUNICATION PLATFORM

(71) Applicants: Donald Paul Schween, Gilbert, AZ (US); Bruce Porter, Queen Creek, AZ (US); Jason Allred, Santaquin, UT (US)

(72) Inventors: Donald Paul Schween, Gilbert, AZ (US); Bruce Porter, Queen Creek, AZ (US); Jason Allred, Santaquin, UT (US)

(21) Appl. No.: 17/523,713

(22) Filed: Nov. 10, 2021

Related U.S. Application Data
(63) Continuation-in-part of application No. 16/719,520, filed on Dec. 18, 2019, now Pat. No. 11,202,329.
(60) Provisional application No. 62/781,232, filed on Dec. 18, 2018.

(51) Int. Cl. H04W 12/086; H04L 29/06; H04W 12/50; H04W 16/26

(52) U.S. Cl. CPC H04W 12/086; H04L 63/0272; H04W 12/03; H04W 16/26; H04W 12/50

(57) ABSTRACT

The disclosed digital wireless private communication platform according to various embodiments may comprise a hub device, a plurality of signal boosters, a lead device, and a plurality of group devices. The hub device may be capable of establishing a wireless personal area network (WPAN) and configured to broadcast a signal based on the WPAN. The plurality of signal boosters may be coupled to each other in a daisy-chain configuration and configured to broadcast the signal within a broad geographic area. The lead device may comprise a lead mobile application operating on the lead device and configured to connect the lead device to the WPAN. Each group device may comprise a group mobile application operating on the group device and configured to connect the group device to the WPAN and establish a communication link between the group device and the lead device.

### CROSS REFERENCE TO RELATED APPLICATION

This application is a continuation-in-part of U.S. patent application Ser. No. 16/719,520, filed Dec. 18, 2019, which claims benefit of U.S. provisional patent application 62/781,232, filed Dec. 18, 2018, the disclosures of which are hereby incorporated entirely herein by reference.

### BACKGROUND OF THE TECHNOLOGY

In the tourism industry, guided tours are immersive excursions that occur in both urban and rural environments where a tour guide can provide a group of tourists with an authentic experience that highlights the local culture.

In a guided tour, the tour guide typically utilizes a conventional communication system, such as a device like a microphone for amplifying the tour guide's voice so that the tourists can hear the tour guide speak. In some instances, the tourists may be provided with various hardware, such as earphones, that may be connected to a sound system. However, excursions, particularly in exotic regions of the world, have become significantly more complex due to stricter border regulations and criminal activity, such as theft and fraud. In this regard, a conventional communication system may be ineffective at keeping both the tourists and the tour guide safe. In addition, a conventional communication system can cause delays and/or problems at international border crossings and can be unreliable and cumbersome for the tourists and the tour guide.

Accordingly, there is a need for an improved communication platform for guided tours that is not dependent on cell towers, third party Wi-Fi networks, or external power grids and that is mobile, digital, wireless, private, and secure.

### SUMMARY OF THE TECHNOLOGY

The disclosed digital wireless private communication platform according to various embodiments may comprise a hub device, a plurality of signal boosters, a lead device, and a plurality of group devices. The hub device may be capable of establishing a wireless personal area network (WPAN) and configured to broadcast a signal based on the WPAN. The plurality of signal boosters may be coupled to each other in a daisy-chain configuration and configured to broadcast the signal within a broad geographic area. The lead device may comprise a lead mobile application operating on the lead device and configured to connect the lead device to the WPAN. Each group device may comprise a group mobile application operating on the group device and configured to connect the group device to the WPAN and establish a communication link between the group device and the lead device.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 is a block diagram of a digital wireless private communication platform in accordance with an embodiment of the present technology;

FIG. 2 is a block diagram of a lead device of a digital wireless private communication platform in accordance with an embodiment of the present technology; and

FIG. 3 is a block diagram of a group device of a digital wireless private communication platform in accordance with an embodiment of the present technology.

### DETAILED DESCRIPTION OF EXEMPLARY EMBODIMENTS

The present technology may be described herein in terms of functional block components. Such functional blocks may be realized by any number of components configured to perform the specified functions and achieve the various results. For example, the present technology may employ various hub devices, lead devices, group devices, signal boosters, mobile applications, modules, and the like, which may carry out a variety of functions. In addition, the present technology may be practiced in conjunction with any number of mobile devices, mobile applications, and the like, and the digital wireless private communication platform described herein is merely one exemplary application for the technology.

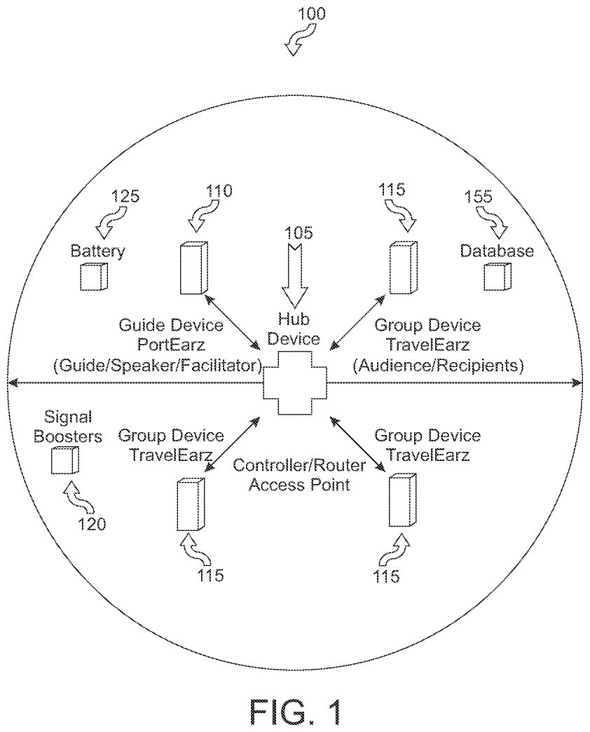

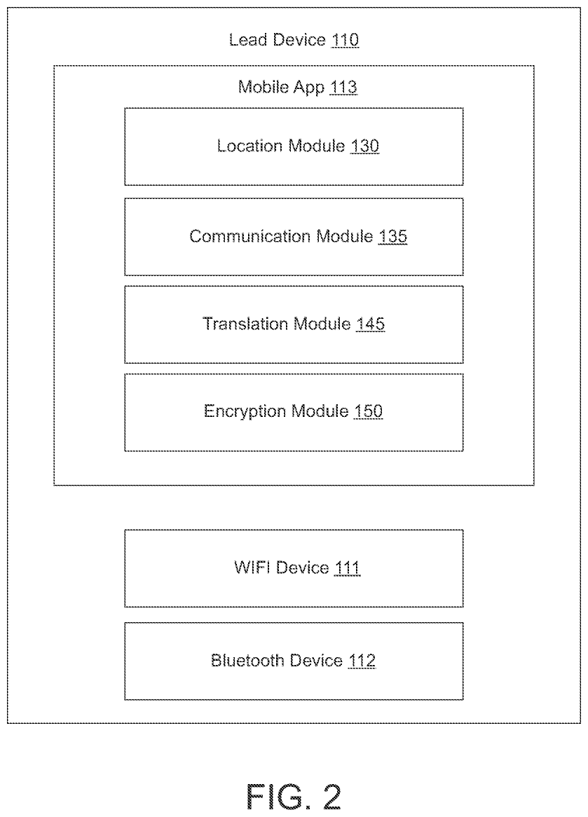

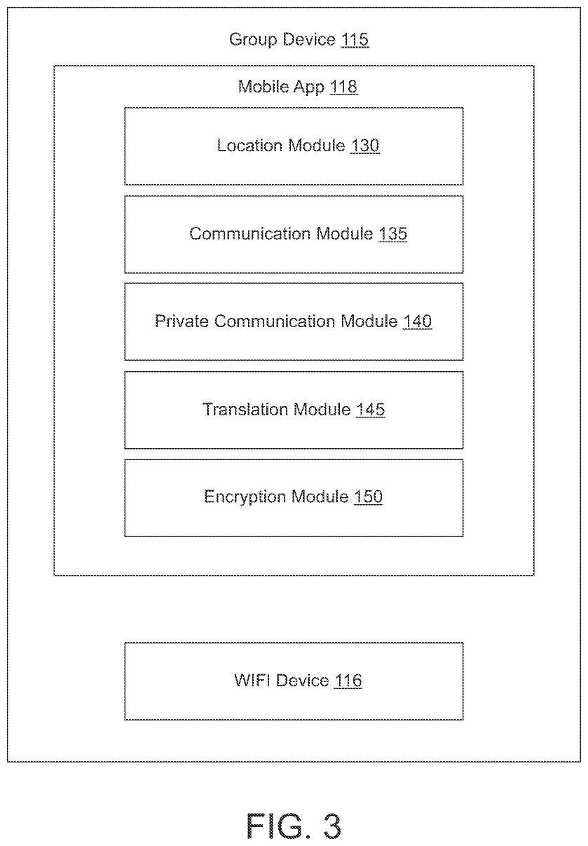

Referring to FIGS. 1-3, a digital wireless private communication platform 100 may comprise a hub device 105, a lead device 110, and a plurality of group devices 115. The platform 100 may further comprise a plurality of signal boosters 120 and a battery 125 for supplying power to one or more components of the platform 100.

The hub device 105, which may be portable, may comprise any suitable device capable of establishing a wireless personal area network (WPAN), such as a router, a controller, an access point, or any combination thereof. The WPAN may comprise any suitable stand-alone private communication network, such as an independent private local area network, i.e., IPLAN, an independent safe local area network device, i.e., ISLAND, or any combination thereof. The hub device 105 may establish the WPAN without utilizing cell towers, power grids, or third-party networks, such as the Internet, third-party Wi-Fi networks, and the like. In this regard, the WPAN may be a private peer-to-peer network that is not dependent on third-party networks. However, at the discretion of the platform's operator, the WPAN may be suitably integrated with one or more third-party networks, such as a mobile personal area network (MPLAN), a local area network (LAN), a wide area network (WAN), and the like. The MPLAN may be a Wi-Fi network, a 5G network, or any combination thereof.

The hub device 105 may be capable of establishing a communication link between the lead device 110 and the plurality of group devices 115 and/or between each of the plurality of group devices 115. The hub device 105 may be configured to generate a signal based on the WPAN and broadcast and/or transmit the signal to a predetermined number of group devices 115, e.g., 150 recipients, within a first geographic area. For example, the hub device 105 may be capable of establishing an independently generated private Wi-Fi network. In this case, the hub device 105 may broadcast a Wi-Fi signal based on the Wi-Fi network. Alternatively, the hub device 105 may be capable of establishing a Bluetooth network. In particular, the hub device 105 may broadcast a Bluetooth signal based on the Bluetooth network so that the lead device 110 may connect to the Bluetooth network. The first geographic area may be circular-shaped and may be defined by the hub device 105, which may be located at the center of the circle, and a predetermined radius. For example, the radius of the first geographic space may be about 150 yards.

In one embodiment, the lead device 110 may be configured to transmit the signal to the hub device 105, the plurality of group devices 115, and one or more third-party networks simultaneously. As an example, the hub device 105 may transmit the signal to a third-party Wi-Fi network via the Internet. In this regard, the lead device 110, the plurality of group devices 115, and one or more third-party devices may connect to the WPAN. Accordingly, friends and/or family members of the group members or others may view a portion of the travel session or even the entire travel session. It will be appreciated that the signal may be transmitted to the third-party networks at the discretion of any suitable person, such as the lead member, platform operator, or the like.

The lead device 110 may comprise any suitable mobile device, such as a smartphone. In addition, the lead device 110 may comprise a first Wi-Fi device 111, a Bluetooth device 112, or any combination thereof. The lead device 110 may be configured to receive the signal and may comprise a lead mobile application 113 suitably configured to operate on the lead device 110 and connect the lead device 110 to the WPAN based on the signal. For example, in the case where the hub device 105 establishes an independent Wi-Fi network, the lead mobile application 113 may connect the first Wi-Fi device 111 to the WPAN based on the Wi-Fi signal. Alternatively, in the case where the hub device 105 establishes a Bluetooth network and transmits a Bluetooth signal to the lead device 110, the lead mobile application 113 may connect the Bluetooth device 112 to the WPAN based on the Bluetooth signal.

Each group device 115 may comprise any suitable mobile device, such as a smartphone. In addition, each group device 115 may comprise a second Wi-Fi device 116. Each group device 115 may be configured to receive the signal and may comprise a group mobile application 118 suitably configured to operate on the group device 115 and connect the group device 115 to the WPAN based on the signal. For example, in the case where the hub device 105 establishes an independent Wi-Fi network and transmits a Wi-Fi signal to the plurality of group devices 115, the group mobile application 118 operating on each group device 115 may connect its respective second Wi-Fi device 116 to the WPAN based on the Wi-Fi signal.

Each signal booster 120 may comprise any suitable device for receiving a signal and retransmitting the signal to expand the coverage of the signal in one or more directions, such as a digipeater, repeater, relay station, and the like. Accordingly, each signal booster 120 may be configured to broadcast the signal within a second geographic area, where the second geographic area may comprise a larger area than the first geographic area and may encompass the first geographic area. In one embodiment, the plurality of signal boosters 120 may be coupled to each other in a daisy-chain configuration to expand the signal coverage in one or more directions, such that the radius of the circle may exceed 150 yards. For example, the radius may be expanded to about 1 mile. The plurality of signal boosters 120 may be located on a hilltop or at the top of various buildings or structures. Alternatively, the plurality of signal boosters 120 may be portable.

It will be appreciated that modifications may be made to the plurality of signal boosters 120 and the manner in which the various components of the platform 100 are connected to each other without departing from the scope of the present invention. As an example, the WPAN may be configured as a mesh network or any other suitable network, so long as the signal coverage can be expanded in one or more directions. In the context of this application, the term “mesh network” means a network in which devices or nodes are linked together, branching off other devices or nodes. Further, the WPAN may be configured as a full mesh or partial mesh topology. In the case where the WPAN is configured as a full mesh network topology, the lead device 110 and the plurality of group devices 115 may be connected directly to each other, albeit wirelessly. In contrast, in the case where the WPAN is configured as a partial mesh network topology, some of the devices, such as the lead device 110 and one or more group devices 115, may be connected directly to other devices, albeit wirelessly, via the network. The type of mesh topology may depend on the overall traffic pattern of the network and the extent to which various devices, such as the lead device 110 and the plurality of group devices 115, nodes, and connections, are at risk of failure.

In various embodiments, the lead mobile application 113 and the group mobile application 118 may each comprise a location module 130 and a communication module 135. In addition, the group mobile application 118 may comprise a private communication module 140. The lead mobile application 113 and the group mobile application 118 may each further comprise a translation module 145 and an encryption module 150.

The location module 130 may be suitably configured to track the location of the plurality of group devices 115 and report the location of each group device 115 to the lead device 110. For example, when the platform 100 is turned on, the location module 130 may transmit an alert to the lead device 110 in the event that one or more of the group devices 115 leaves the first geographic area and/or the second geographic area. Accordingly, in the event one or more group members is separated from the lead member and/or other group members, the platform 100 may allow the lead member and/or the group members to find the missing member.

The communication module 135 may permit the lead device 110 and the plurality of group devices 115 to communicate with each other in any suitable manner. For instance, the lead device 110 and the plurality of group devices 115 may communicate with each other through messages in the form of text, audio, video, and the like. The communication module 135 may be configured to convert text messages to audio messages and vice versa. The communication module 135 may also be configured to transmit and receive audio messages, data signals, video messages, in real time with little to no latency. For example, the communication module 135 may be utilized to transmit digital voice signals, audio signals, and video signals between devices with a latency of no more than 200 milliseconds.

The private communication module 140 may be configured to establish a private communication link between two or more group devices 115, such that the two or more group devices 115 may communicate directly with each other without involving the lead device 110 and/or other group devices 115. Accordingly, the group members may communicate privately with only those whom they give access, thereby providing security by limiting the devices that may access the platform 100. This communication may include the sharing of content obtained using a connected device. As an example, the private communication module 140 may include a private chat room and/or a photo or file sharing channel so that participants can chat and share data with each other. The private communication module 140 may be configured to transmit and receive audio and video streams with little to no latency. Specifically, the private communication module 140 may allow group members to interact with each other by sharing video or audio streams with each other in real-time.

The translation module 145 may be configured to receive and service requests for translation. In particular, the translation module 145 may be configured translate the interface of the lead mobile application 113 and/or the interface of the group mobile application 118 from any suitable first language to any suitable second language. In addition, the translation module 145 may translate a variety of information or data, such as power point files, PDF files, text messages, audio messages, video messages, and the like, from any suitable first language to any suitable second language. The first language may be English, French, German, Spanish, or any other language. Similarly, the second language may be English, French, German, Spanish, or any other language.

The encryption module 150 may be configured to encrypt the communication link established between the lead device 110 and the plurality of group devices 115 and/or between each of the plurality of group devices 115. In particular, the encryption module 150 may encrypt the messages and/or information that is exchanged between the lead device 110 and the plurality of group devices 115 and/or between the plurality of group devices 115. The encryption module 150 may be turned on or off at the discretion of the lead member and/or the group members and may be configured to encrypt the messages in any suitable manner, such as by key cryptography, hash functions, and the like.

In various embodiments, the platform 100 may further comprise a database 155. The database 155 may be accessible to the lead device 110 and the plurality of group devices 115. In particular, the database 155 may be communicatively linked to the lead device 110 and the plurality of group devices 115. The database 155 may be configured to securely store a variety of identifying information, health information, emergency information, and the like. For example, the identifying information may comprise each group member's first name, last name, date of birth, gender, race, cell number, home address, and the like. The health information may comprise each group member's dietary restrictions, allergies, disabilities, and the like. The emergency information may comprise contact information for family contacts, passport information, foreign embassy information, and the like. The identifying information, health information, and emergency information may be used to create a profile for each group member. The group members' profiles may be saved to the database 155. If the identifying information, health information, and/or emergency information changes at a later time, the relevant group members' profiles may be updated and saved to the database 155 to reflect the changes.

The lead mobile application 113 may be configured to record any or all video signals, audio signals, and other information that is exchanged between the lead mobile application 113 and the group mobile application 118 during a travel session. In the context of this Application, a “travel session” means a guided tour session where a tour guide provides a group of tourists with an authentic experience that highlights the local culture. In particular, the lead member may start recording the travel session via the lead mobile application 113. The video signals, audio signals, and other information may be recorded in any suitable manner and then stored on the database 155 for later access. In this regard, the travel sessions can be monetized while allowing the group members to manage their privacy. The platform 100 may, however, be monetized in any suitable manner. For instance, the platform 100 may incorporate advertisements into the group mobile application 118. In this regard, the platform 100 may be monetized through revenue generated via the advertisements.

The battery 125 may be connected to one or more components of the platform 100 and may be configured to supply power to the one or more components. In particular, the battery 125 may be coupled to the hub device 105 and may supply power to the hub device 105. For example, in one embodiment, the battery 125 may be coupled to the hub device 105 via a power terminal (not shown). In another embodiment, the battery 125 may be coupled to the hub device 105 via one or more wires (not shown) coupled to the hub device 105. The battery 125 may comprise any suitable disposable, replaceable, or rechargeable battery, such as an alkaline battery, a lead acid battery, a nickel cadmium battery, a nickel metal hydride battery, a lithium-ion battery, and the like. It will be appreciated that modifications may be made to the battery 125 without departing from the scope of the invention. For example, instead of the battery 125, alternative energy sources, such as inductive, solar, and chemical energy sources, may be used to power various components of the platform 100, including the hub device 105. During operation, the battery 125 may supply power to the hub device 105 for at least eight hours.

In the foregoing specification, the technology has been described with reference to specific exemplary embodiments. Various modifications and changes may be made, however, without departing from the scope of the present technology as set forth in the claims. The specification and figures are illustrative, rather than restrictive, and modifications are intended to be included within the scope of the present technology. Accordingly, the scope of the technology should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims. Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise,” “comprises,” “comprising,” “having,” “including,” “includes,” or any variation thereof, are intended to reference a non-exclusive inclusion, such that a process, method, article, composition, or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied, or otherwise particularly adapted to specific environments, manufacturing specifications, design parameters or other operating requirements without departing from the general principles of the same.

1. A digital wireless private communication platform, comprising:
a hub device capable of establishing a wireless personal area network (WPAN) and configured to broadcast a signal based on the WPAN;
a plurality of signal boosters coupled to each other in a daisy-chain configuration and configured to broadcast the signal within a broad geographic area;
a lead device comprising a lead mobile application operating on the lead device and configured to connect the lead device to the WPAN, wherein the lead mobile application comprises a location module and a communication module; and
a plurality of group devices, wherein each of the plurality of group devices comprises a group mobile application operating on the group device, and wherein the group mobile application comprises a location module, a communication module and a private communication module and configured to connect the group device to the WPAN and establish a communication link between the group device and the lead device.

2. The platform of claim 1, wherein the WPAN is a mobile personal area network (MPLAN), an independent private local area network (IPLAN), an independent safe local area network device (ISLAND), or any combination thereof.

3. The platform of claim 2, wherein the MPLAN is a Wi-Fi network, a 5G network, or any combination thereof.

4. The platform of claim 1, wherein the lead device and the plurality of group devices communicate with each other by operation of the communication module.

5. The platform of claim 1, wherein two or more of the plurality of group devices operate the private communication module to establish a private communication connection between the two or more of the plurality of group devices.

6. The platform of claim 5, wherein the private communication connection allows for communication between only the group devices with the established communication connection.

7. The platform of claim 1, wherein operation of the location module of the lead mobile application and the location modules on the plurality of group devices comprises the location module tracking location of the plurality of group devices and receiving an alert if a group device of the plurality of group devices travels outside of the limited geographic area.

8. The platform of claim 1, wherein the broad geographic area comprises a predetermined radius around the hub device, and wherein the hub device is portable.

9. The platform of claim 8, wherein the radius is about 1 mile.

10. The platform of claim 1, wherein each of the lead device and the plurality of group devices further comprises an encryption module configured to encrypt the communication link between the lead device and the plurality of group devices.

11. A digital wireless private communication platform, comprising:
a hub device capable of establishing an independent dedicated Wi-Fi network and configured to broadcast a Wi-Fi signal based on the Wi-Fi network;
a plurality of signal boosters coupled to each other in a daisy-chain configuration and configured to broadcast the Wi-Fi signal within a broad geographic area;
a lead device comprising a lead mobile application operating on the lead device and configured to connect the lead device to the Wi-Fi network, wherein the lead mobile application comprises a location module and a communication module; and
a plurality of group devices adapted to communicate with the lead device, wherein each group device comprises a group mobile application operating on the group device, and wherein the group mobile application comprises a location module, a communication module and a private communication module and configured to connect the group device to the Wi-Fi network and establish a communication link between the group device and the lead device.

12. The platform of claim 11, wherein the lead device and the plurality of group devices communicate with each other by operation of the communication module.

13. The platform of claim 11, wherein two or more of the plurality of group devices operate the private communication module to establish a private communication connection between the two or more group devices.

14. The platform of claim 13, wherein the private communication connection allows for communication between only the group devices with the established communication connection.

15. The platform of claim 11, wherein operation of the location module of the lead mobile application and the location modules on the plurality of group devices comprises the location module tracking location of the plurality of group devices and receiving an alert if a group device of the plurality of group devices travels outside of the limited geographic area.

16. The platform of claim 11, wherein the broad geographic area comprises a predetermined radius around the hub device, wherein the hub device is portable.

17. The platform of claim 16, wherein the radius is about 1 mile.

18. The platform of claim 11, wherein each of the lead device and the plurality of group devices further comprises an encryption module configured to encrypt the communication link between the lead device and the plurality of group devices.
